(19) United States
(12) Patent Application Publication
(10) Pub. No.: US 2012/0027881 A1
(43) Pub. Date: Feb. 2, 2012

(54) MOLD

(75) Inventors: XIN-JIN GUI, Tu Cheng (TW); Gang-fu Cai, Tu Cheng (TW); Kun-hsueh Chiang, Tu Cheng (TW)

(73) Assignee: Cheng Uei Precision Industry Co., LTD., Tu Cheng City (TW)

(21) Appl. No.: 12/848,963

(22) Filed: Aug. 2, 2010

(51) Int. Cl. B29C 33/44

(52) U.S. Cl. 425/161

(57) ABSTRACT

A mold includes upper and lower mold members and a machine control unit. The lower mold member includes a support board, a molding mechanism mounted on the support board, and an ejection mechanism. The support board forms a receiving compartment. The molding mechanism includes a mold cavity. The machine control unit is mounted in the receiving compartment of the support board and includes an optic sensor. With the arrangement of the optic sensor of the machine control unit, the mold can detect the returned and non-returned statuses of the ejection mechanism and transmits the result of detection to the molding machine of the mold, whereby the molding machine can be timely and correctly informed of the status of the ejection mechanism for correctly issuing a subsequent operation instruction. In this way, the potential risk that the mold is damaged by improper operation of the molding machine can be eliminated.

### BACKGROUND OF THE INVENTION

1. Field of the Invention

The present invention generally relates to a mold, and in particular to a mold combined with a machine control unit.

2. The Related Arts

Modern industries use molds to perform mass production. A mold generally comprises an ejection mechanism for ejecting a molded product and a machine control unit that detects if the ejection mechanism is properly returned after the ejection of a molded product. The machine control unit transmits a signal indicating the return of the ejection mechanism to the molding machine and the molding machine issues a control instruction for starting the next operation. Reference is now made to FIG. 1 of the attached drawings, which shows a conventional mold 100′. The mold 100′ comprises upper and lower mold members 10′ and a contact type machine control unit 20′. The contact type machine control unit 20′ comprises a body 21′, which has a top face carrying thereon a spring plate 22′ and a projection 23′ that is arranged below and spaced from the spring plate 22′ by a predetermined distance. The lower mold member 10′ comprises an ejection mechanism 11′, and the ejection mechanism 11′ comprises a depression block 111′ that is positioned against the spring plate 22′ and a plurality of ejection pins 112′. After a molded product is cooled down in the mold and properly shaped, the mold 100′ is opened, and the ejection mechanism 11′ operates to eject the molded product out of the mold. The ejection mechanism is then acted upon by the spring force of the springs 30′ for returning to the original position, where the depression block 111′ depresses down the spring plate 22′ to make the spring plate 22′ engaging the projection 23′. The body 21′therefore issues a signal indicating the returning of the ejection mechanism 11′ to the molding machine through a signal transmission cable. As a result of such a signal, the molding machine issues an operation instruction of closing the mold for next cycle of molding operation.

However, the known contact type machine control unit 20′ is disadvantageous in that the spring plate 22′ is susceptible to permanent deformation and loss of spring force after repeated operations so that the spring plate 22′ gets in contact with the projection 23′ before the ejection mechanism 11′ is properly returned to the original position. In other words, a molded product may get ejected when the mold 100′ has not yet been completely opened, or the mold is closed before the ejection mechanism 11′ is not properly returned. This eventually causes undesired damage to the mold 100′.

### SUMMARY OF THE INVENTION

An objective of the present invention is to overcome the problem discussed above by providing a mold that comprises a machine control unit for timely and correctly detect the status of an ejection mechanism.

To achieve the above objective, the present invention provides a mold, which comprises an upper mold member, a lower mold member, and a machine control unit. The lower mold member comprises a support board, a molding mechanism mounted on the support board, and an ejection mechanism. The support board has a front side forming a receiving compartment. The molding mechanism comprises a mold cavity. The machine control unit is mounted in the receiving compartment of the support board and comprises an optic sensor.

As described above, the mold of the present invention comprises a machine control unit that comprises an optic sensor to detect the returned and non-returned statuses of the ejection mechanism and transmit the result of detection to the molding machine of the mold, whereby the molding machine can be timely and correctly informed of the status of the ejection mechanism for correctly issuing a subsequent operation instruction. In this way, the potential risk that the mold is damaged by improper operation of the molding machine can be eliminated.

### BRIEF DESCRIPTION OF THE DRAWINGS

The present invention will be apparent to those skilled in the art by reading the following description of preferred embodiments of the present invention and the best modes for carrying out the present invention, with reference to the attached drawings, in which:

FIG. 1 is a front view of a conventional mold, in which an upper mold member and a lower mold member are shown in sections; and

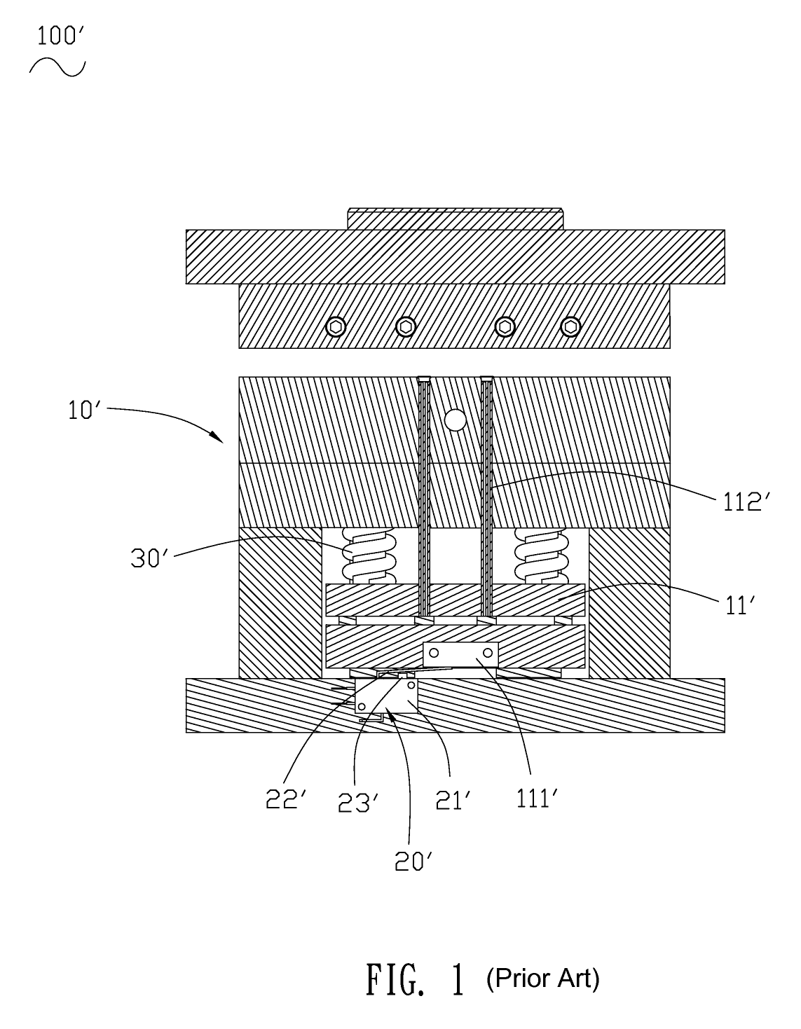

FIG. 2 is a front view of a mold according to the present invention, in which an upper mold member and a lower mold member are shown in sections.

### DETAILED DESCRIPTION OF PREFERRED EMBODIMENT

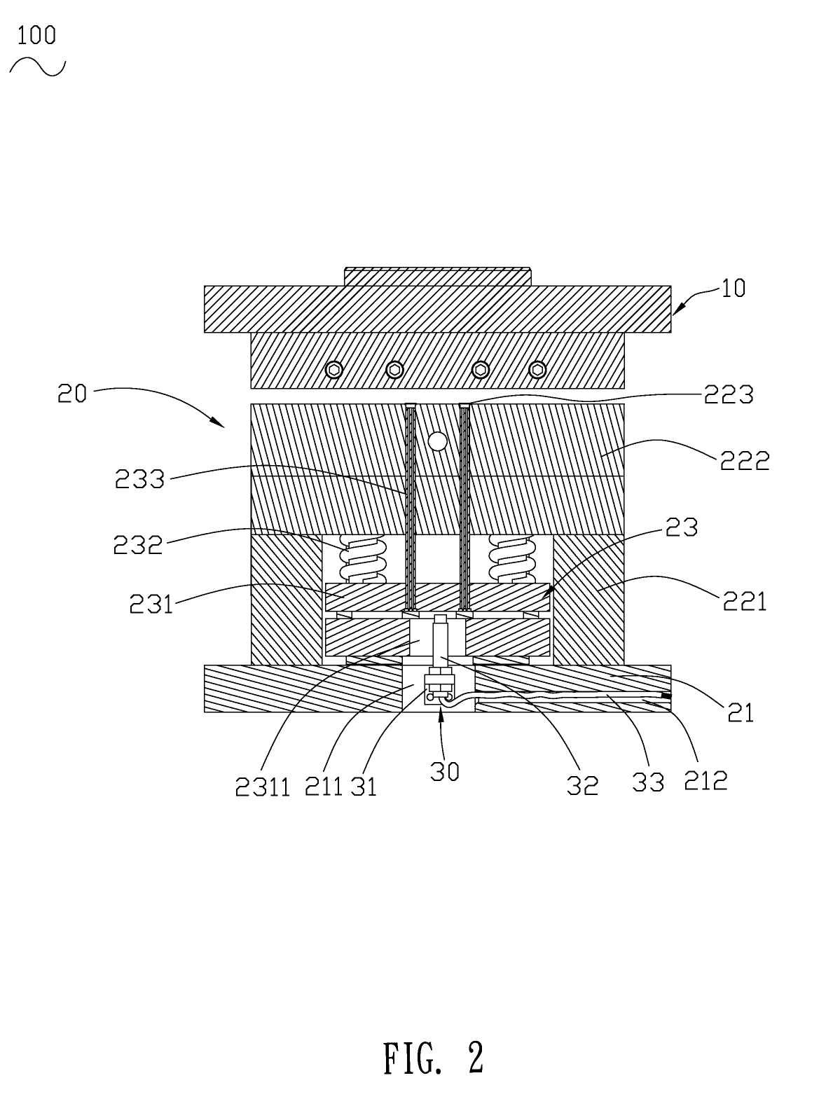

With reference to the drawings and in particular FIG. 2, the present invention provides a mold, which is generally designated at 100. The mold 100 comprises an upper mold member 10, a lower mold member 20, and a machine control unit 30 mounted on the lower mold member 20.

The lower mold member 20 comprises a support board 21, a molding mechanism mounted on the support board 21, and an ejection mechanism 23. In the embodiment illustrated, the support board 21 is in the form of a flat plate, but it can be of any other desired shape and configuration. The support board 21 comprises an upright sliding rod (not shown) mounted thereon. The support board 21 has a front side, which forms a receiving compartment 211 extending vertically through the support board 21 and a cable channel 212 in communication with the receiving compartment 211. The molding mechanism comprises two side boards 221 that mounted on a top surface of the support board 21 in a vertically erected manner and a lower mold board 222 mounted atop the two side boards 221. The lower mold board 222 forms a mold cavity 223.

The ejection mechanism 23 is arranged between the two side boards 221. In the embodiment illustrated, the ejection mechanism 23 comprises an ejection plate 231, springs 232, and a plurality of ejection pins 233 vertically erected and mounted on the ejection plate 231. The ejection plate 231 has a lower portion forming a receiving slot 2311. The ejection plate 231 is slidably fit over the sliding rod of the support board 21 for vertically sliding along the sliding rod. The ejection pins 233 move up and down with the ejection plate 231 and extend upward through the lower mold board 222 to project into the mold cavity 223.

The machine control unit 30 is received and fixed in the receiving compartment 211 of the support board 21 and comprises a mounting plate 31, an optic sensor 32, and a transmission cable 33.

The optic sensor 32 is fixed to the support board 21 by the mounting plate 31. The optic sensor 32 has an upper portion that is received in the receiving slot 2311 of the ejection plate 231. The optic sensor 32 comprises a transmitter and a receiver (not shown). The optic sensor 32 has a lower end electrically connected to a signal transmission cable 33, which is set in the cable channel 212 of the support board 21.

When the mold 100 according to the present invention 100 is completely opened, the ejection mechanism 23 is caused to move upward from a home position and thus drives the ejection pins 233 upwards to eject a molded product out of the mold. Then, the ejection mechanism 23, under the action of the spring force of the springs 232, returns to its home position. During this process, the transmitter of the optic sensor 32 continuously emits and transmits a light beam, such as an infrared beam, and the receiver is set in a standby condition for receiving the light beam. Once the optic sensor 32 of the support board 21 detects an upper portion of the ejection plate 231 of the ejection mechanism 23 is approaching to a predetermined distance, meaning the upper portion of the ejection plate 231 effectively reflecting the light beam from the transmitter of the optic sensor 32 back to the receiver, the optic sensor 32 issues a signal indicating the returning of the ejection mechanism 23 and transmits the signal through the transmission cable 33 to the molding machine so that the molding machine may correctly issue a subsequent operation instruction, such as closing the mold.

In summary, the mold 100 according to the present invention 100 comprises a machine control unit 30 that comprises an optic sensor 32 to detect the ejection mechanism 23 reaching a predetermined location, for correctly determining that the ejection mechanism 23 is properly returned to the home position, and transmit the result of detection to the molding machine so that the molding machine can be timely and correctly informed of the status of the ejection mechanism for correctly issuing a subsequent operation instruction. In this way, the potential risk that the mold is damaged by improper operation of the molding machine can be eliminated.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A mold, comprising:
an upper mold member;
a lower mold member, which comprises a support board, a molding mechanism mounted on the support board, and an ejection mechanism, the support board having a front side forming a receiving compartment, the molding mechanism forming a mold cavity; and
a machine control unit, which is mounted in the receiving compartment of the support board and comprises an optic sensor.

2. The mold as claimed in claim 1, wherein the machine control unit comprises a mounting plate that is fixed inside the receiving compartment, the optic sensor being mounted to the mounting plate.

3. The mold as claimed in claim 1, wherein the support board forms a cable channel in communication with the receiving compartment, the optic sensor being electrically connected a signal transmission cable, which is received through the cable channel of the support board.

4. The mold as claimed in claim 1, wherein the molding mechanism comprises two side boards mounted on a top surface of the support board in a vertically erected manner and a lower mold board mounted atop the two side boards.

5. The mold as claimed in claim 1, wherein the ejection mechanism comprises an the ejection plate, springs and a plurality of ejection pins vertically erected and mounted on the ejection plate, the ejection pins being movable with the ejection plate and extendable through the lower mold board to project into the mold cavity.

6. The mold as claimed in claim 5, wherein the ejection plate forms a receiving slot, the optic sensor being mounted inside the receiving compartment of the support board by the mounting plate to have an upper portion of the optic sensor received in the receiving slot of the ejection plate.
